(19) United States
(12) Patent Application Publication
(10) Pub. No.: US 2020/0124874 A1
(43) Pub. Date: Apr. 23, 2020

(54) CALIBRATION OF ACTIVATION THRESHOLD METHOD AND SYSTEM

(71) Applicant: Johnson & Johnson Vision Care, Inc., Jacksonville, FL (US)

(72) Inventors: Donald K. Whitney, Melbourne, FL (US); Adam Toner, Jacksonville, FL (US)

(21) Appl. No.: 16/163,282

(22) Filed: Oct. 17, 2018

(51) Int. Cl. G02C 7/04; G02C 11/00

(52) U.S. Cl. CPC G02C 7/041; G02C 11/10

(57) ABSTRACT

A method for controlling functions in a plurality of multiple wearable ophthalmic lenses each having elements including at least one sensor, a system controller, communication elements, a calibration controller and a power source, the method includes; initiating a calibration by the system controller, causing the at least one sensor to provide control signals to the system controller, causing the at least one sensor to further provide calibration signals to the calibration controller, and the calibration controller conducting a calibration sequence based on the calibration signals from the at least one sensor as a result of user actions which are sensed by the at least one sensor and providing calibration control signals to the system controller.

### BACKGROUND

### 1. Field of Invention

The present invention relates to user-wearable ophthalmic lenses having embedded elements, and more specifically, to use the embedded elements to conduct a calibration and customization sequence based upon user actions.

### 2. Discussion of the Related Art

Near and far vision needs exist for all. In young non-presbyopic patients, the normal human crystalline lens has the ability to accommodate both near and far vision needs, and those viewing items are in focus. As one ages, the vision is compromised due to a decreasing ability to accommodate as one ages. This is called presbyopia.

The use of adaptive optics/powered lens products are positioned to address this and restore the ability to see items in focus. But what is required is knowing when to “activate/actuate” the optical power change. A manual indication or use of a key fob to signal when a power change is required is one way to accomplish this change. However, leveraging anatomical/biological conditions/signals may be more responsive, more user friendly and potentially more “natural” and thus more pleasant.

A number of things happen when we change our gaze from far to near. Our pupil size changes and our line of sight from each eye converges in the nasal direction coupled with a somewhat downward component as well. However, to sense/measure these items is difficult, one also needs to filter out certain other conditions or noise (e.g.: blinking, what to do when one is lying down, or head movements).

In reference to FIG. 4, when observing an object in each eye the visual axis points toward the object or Target. Since the two eyes are spaced apart (distance b) and the focal point is in front, a triangle is formed. Forming a triangle allows the relationship of angles (OL and OR) of each visual axis to the distance (Y) the object is from the eyes to be determined. Since the distance (Y) is what determines if a change in optical power is required, then knowing the angles and the distance between the eyes and using simple math would allow a system to make a decision regarding when to change the optical power.

At a minimum, sensing of multiple items may be required to remove/mitigate any false positive conditions that would indicate a power change is required when that is not the case. Use of an algorithm may be helpful. Additionally, threshold levels may vary from patient to patient, thus some form of calibration will likely be required as well.

### SUMMARY

According to one aspect of the present invention, a method for controlling functions in user-wearable ophthalmic lens having elements including at least one sensor, a system controller, communication elements, a calibration controller and a power source, the method includes causing the at least one sensor to provide control signals to the system controller; causing the at least one sensor to further provide calibration signals to the calibration controller; and the calibration controller conducting a calibration sequence based on the calibration signals from the at least one sensor as a result of user actions which are sensed by the at least one sensor and providing calibration control signals to the system controller.

According to another aspect of the present invention, a user-wearable ophthalmic lens includes: elements configured to be embedded within the user-wearable ophthalmic lens, the elements includes, at least one sensor; a system controller receiving control signals from the at least one sensor; a calibration controller receiving calibration signals from the at least one sensor; and the calibration controller being configured to conduct a calibration sequence based on the calibration signals from the at least one sensor as a result of user actions which are sensed by the at least one sensor and providing calibration control signals to the system controller.

According to another aspect of the present invention, a system includes: elements configured to be embedded within user-wearable ophthalmic lens, the elements includes, at least one sensor; a system controller receiving control signals from the at least one sensor; a calibration controller receiving calibration signals from the at least one sensor, the calibration controller being configured to conduct a calibration sequence based on the calibration signals from the at least one sensor as a result of user actions which are sensed by the at least one sensor and providing calibration control signals to the system controller, and; communication elements communicating with the elements and a smart phone to control the elements.

### BRIEF DESCRIPTION OF THE OF THE DRAWINGS

FIG. 1 shows an example of an implementation according to an embodiment of the present invention.

FIG. 2 shows a flowchart according to an embodiment of the present invention.

FIG. 3 shows another example of an implementation according to an embodiment of the present invention.

FIG. 4 shows an example of focus determination.

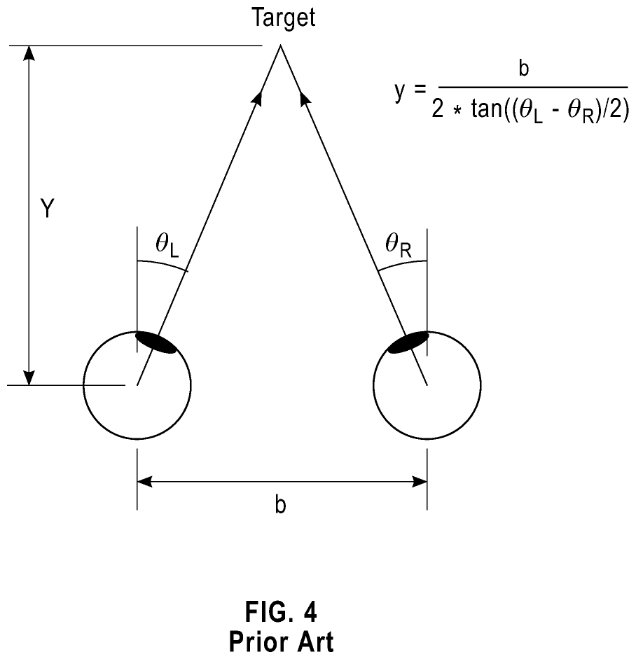

FIG. 5 shows another flowchart according to an embodiment of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

Because everyone's eyes are a bit different, (e.g.: pupil spacing and location, lens-on-eye position, etc.), even at a fixed close distance, initial vergence angles will differ from patient to patient. It may be important once the lenses are placed on the eye to calibrate what the initial vergence angle is, so that differences in this angle can be assessed while in service. This value can be used for subsequent calibration calculations.

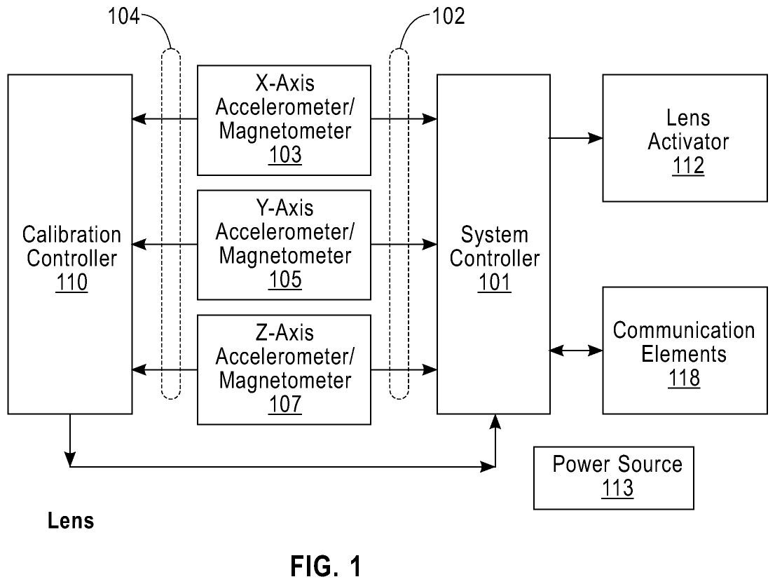

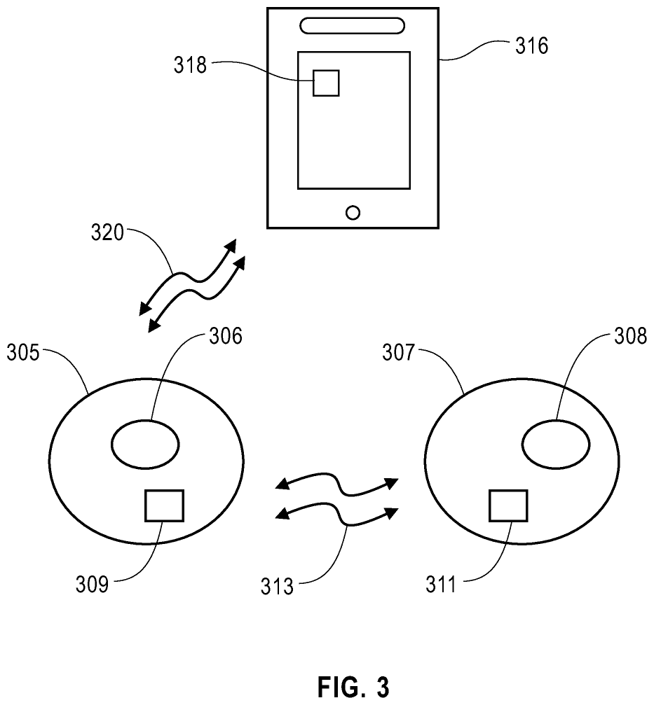

Now referring to FIG. 1, shows a system according to an embodiment of the present invention. A system controller 101 controls a lens activator 112 that changes the adaptive optics/powered lens (see FIG. 3) to control the ability to see both near and far items in focus. The system controller 101 receives control signals 102 from a plurality of multidimensional sensors. A first multidimensional sensor includes an X-axis accelerometer 103. A second multidimensional sensor includes a Y-axis accelerometer 105. A third multidimensional sensor includes a Z-axis accelerometer 107. The plurality of multidimensional sensors (103, 105 and 107) further provide calibration signals 104 to a calibration controller 110. The calibration controller 110 conducts a calibration sequence based on the calibration signals from the plurality of multidimensional sensors (103, 105 and 107) as a result of user actions which are sensed by the plurality of multidimensional sensors (103, 105 and 107) and provides calibration control signals to the system controller 101. The system controller 101 further receives from and supplies signals to communication elements 118. Communication elements 118 allows for communications between user lenses and other devices such as a near-by smartphone. Further functionality of the above embedded elements is described hereafter.

A power source 113 supplies power to all of the above system elements. The power may be supplied from a battery, a primary cell, an energy harvester, or other suitable means as is known to one of ordinary skill in the art. Essentially, any type of power source 113 may be utilized to provide reliable power for all other components of the system. In an alternative embodiment, communication functionality is provided by an energy harvester that acts as the receiver for the time signal, for example in an alternative embodiment, the energy harvester is a solar cell or a radio frequency (RF) receiver, which receives both power and a time-base signal (or indication). In a further alternative embodiment, the energy harvester is an inductive charger, in which power is transferred in addition to data such as RFID. In one or more of these alternative embodiments, the time signal could be inherent in the harvested energy, for example N*60 Hz in inductive charging or lighting.

As another embodiment, the three-axis accelerometers can be replaced by a three-axis magnetometer. Calibration would be similar because each axis would potentially require calibration at each extreme of each axis.

In the context of using sensors to determine vergence, specifically accelerometers, there are opportunities to calibrate. Offsets, due to the micro-electromechanical systems (MEMS) and/or due to the electronics, mounting on the interposer, etc. can cause variations with the algorithms and thus cause some errors in the measurement of vergence. In addition, human anatomy from person to person is different. For instance, eye to eye space can vary from 50 to 70 mm and can cause a change in trigger points based on eye spacing alone. So there is a need to take some of these variables out of the measurement, thus calibration and customization performed by the current embodiment when the lenses are on the user. This serves to improve the user experience by both adding the preferences of the user and to reduce the dependencies of the above-mentioned variations.

The accelerometers (103, 105 and 107) measure acceleration both from quick movements and from gravity (9.81 m/s²). The multidimensional sensors (103, 105 and 107) usually produce a code that is in units of gravity (g). The determination of vergence depends on the measurement of gravity to determine position, but other methods may depend on the acceleration of the eye. There are going to be differences and inaccuracies that will require base calibration before use calibration.

The current embodiment uses three sensors on each lens. However, calibration may be done using two sensors, for example the X-axis accelerometer 103 and the Y-axis accelerometer 105. In at least one further embodiment, each accelerometer has a full scale plus, full scale minus, and zero position. The errors could be offset, linearity, and slope errors. A full calibration would calibrate to correct all three error sources for all of axes sensors being used.

One way to calibrate the sensors is to move them such that each axis is completely perpendicular with gravity, thus reading 1 g. Then the sensor would be turned 180 degrees and it should read −1 g. From two points, the slope and intercept can be calculated and used to calibrate. This is repeated for the other two sensors. This is an exhaustive way of calibrating the sensors and thus calibrating the vergence detection system.

Another way is to reduce the calibration effort for the lens by having the wearer do just one or two steps. One way is to have the wearer look forward, parallel to the floor, or at a distant wall. Measurements taken at this time can be used to determine the offset of each axis. Determining the offset for each axis in the area where the user will spend most of the time provides a greater benefit to maintain accuracy.

Given that everyone is a little different, customizable features can provide a better user experience for all users than a “one size fits all” approach. When using the lens with just two modes, accommodation and gaze, then at the point where there is a switch from gaze to accommodation one can have several parameters in addition to the switching threshold that would affect the user experience.

The threshold going from gaze to accommodation depends on the user, the user's eye condition, the magnification of the lens, and the tasks. For reading, the distance between the eye and a book is about 30 cm, where computer usage is about 50 cm. A threshold set for 30 cm would not work well for computer work, but 50 cm would work for both. However, this longer threshold could be problematic for other tasks by activating too early, depending on the magnification and the user's own eye condition. Thus, the ability to alter this threshold, both when the lens is first inserted and at any time afterwards as different circumstances could require different threshold points, provides the user customization to improve visibility and comfort. Even having several preset thresholds are possible and practical, where the user would choose using the interfaces described here to select a different threshold. In alternative embodiments, the user could alter the threshold or other parameters by re-calibrating as described hereafter.

Still referring to FIG. 1, switching from gaze to accommodation, the system uses the threshold as the activation point. However, going from accommodation to gaze the threshold is shifted to a greater distance, which is called hysteresis. Accounting for hysteresis is added in order to prevent uncertainty when the user is just at the threshold and there are small head movements which may cause it to switch from gaze to accommodation to gaze, etc. Most likely, the user will be looking at a distant target when he/she wants to switch, so the changing of the threshold is acceptable. The hysteresis value can be determined in several ways: one, the doctor fitting the lenses can change it; two, the user can change this value via a lens interface; and three, an adaptive algorithm can adjust it based on the habits of the user.

Custom Modes are common now in cars, i.e., sport, economy, etc. which allow the user to pick a mode based on anticipated activity where the system alters key parameters to provide the best experience. Custom Modes are also integrated into the lens of at least one embodiment. Calibration and customization settings can be optimized for a given mode of operation. If the user is working in the office, it is likely that the user will need to go between states (gaze and accommodation), or even between two different vergence distances because of the nature of the tasks. Changes in the threshold, hysteresis, noise immunity, and possible head positions would occur to provide quicker transitions, possible intermediate vergence positions, and optimization for computer tasks, as well as, tasks that there is a lot if switching between gaze and accommodation. Thus, options to switch the lens into different modes to optimize the lens operation can provide an enhanced user experience. Furthermore, in an “Exercise” mode, the noise filtering is increased to prevent false triggering and additional duration of positive signal is required before switching to prevent false switching of the lens being triggered by stray glances while running. A “Driving” mode might have the lens being configured for distant use or on a manual override only. Of course, various other modes that could be derived as part of some of the embodiments of the present invention.

In today's world, a smartphone is becoming a person's personal communications, library, payment device, and connection to the world. Applications (or apps) on the smartphone or tablet cover many areas and are widely used. One possible way to interact with the lens(es) in at least one embodiment is to use an application. The application could provide ease of use where written language instructions are used and the user can interact with the app providing clear instructions, information, and feedback. Voice activation options may also be included. For instance, the app provides the prompting for the sensor calibrations by instructing the user to look forward and prompting the user to acknowledge the process start. The app could provide feedback to the user to improve the calibration and instruct the user what to do if the calibration is not accurate enough for optimal operation. This would enhance the user experience.

Additional indicators, if the smartphone or tablet was not available, can be simple responses from the system to indicate start of a calibration cycle, successful completion, and unsuccessful completion. Methods to indicate operation include, but not limited to, blinking lights, vibrating haptics drivers, and activating the lens. Various patterns of activation of these methods could be interpreted by the user to understand the status of the lens. The user can use various methods to signal the lens that he/she is ready to start or other acknowledgements. For instance, the lens could be opened and inserted into the eyes awaiting a command. Blinks or even closing one's eyes could start the process. The lens then would signal the user that it is starting and then when it finishes. If the lens requires a follow-up, it signals the user and the user signals back with a blink or eye closing.

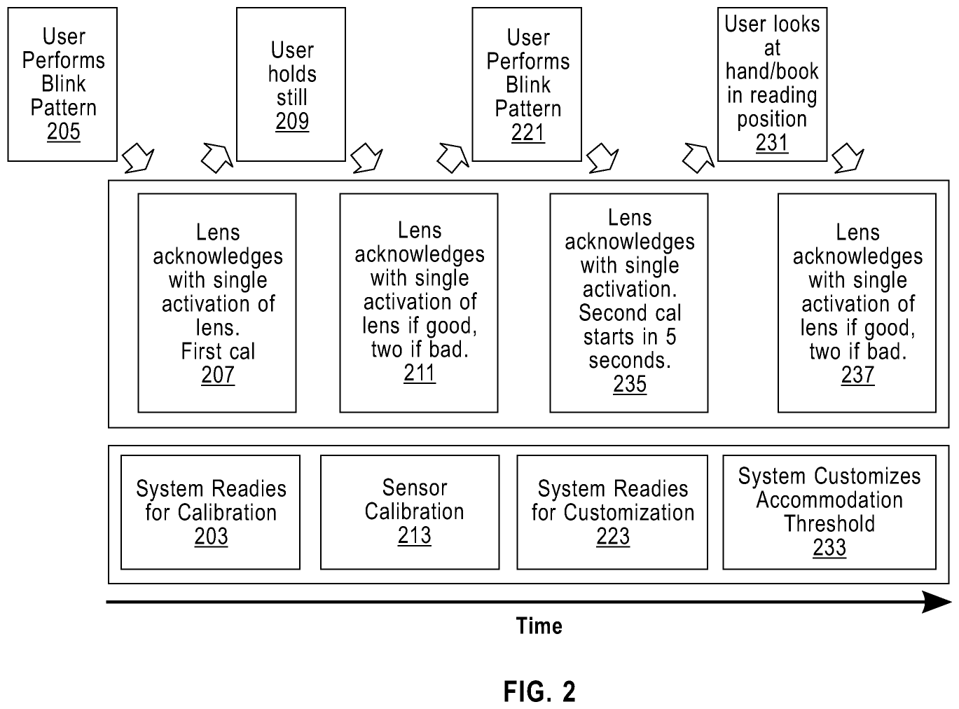

Referring to FIG. 2, one method according to an embodiment of the present invention is depicted. The process starts at an initial time (far left of the figure) and proceeds forward in time. Once the lens (see FIG. 3) is inserted, the system readies for calibration 203. The user performs a blink pattern 205. The lens acknowledges with a single momentary activation and then deactivation of the lens 207 to signal the user that the calibration procedure is about to start. The user looks forward at a distance target and holds still 209 as the system and the sensor calibration 213 starts. The lens acknowledges with a single momentary activation and then deactivation of the lens if the first stage of calibration is acceptable 211. If the initial calibration is unacceptable, then the lens acknowledges with a double momentary activation and deactivation 211. If the calibration is bad, then the user must restart the calibration process 205. After the initial calibration, the system is ready for customization 223. The user conducts another blink pattern 221. The lens acknowledges with an activation of the lens where it stays on and a second calibration/customization is started in some fixed time 235 as part the system customization accommodation threshold 233. The user then looks at either his/her hand or a book at reading position 231. The lens acknowledges with a single momentary deactivation of the lens if the second stage of calibration customization is good 237. If the second stage of calibration customization is bad, then the user must restart the calibration customization process 223. Once the lens acknowledges with a single activation of the lens that the second stage of calibration customization is good 237 the system has the completed customization accommodation calibration and the lens is ready for full use by the user.

Other embodiments to customize the threshold can be accomplished. One way is to have the user's doctor determine the comfortable distance for the user by measuring the distance between the eyes of the patent and the typical distances for certain tasks, and then calculate the threshold. From there, using trial and error methods, the comfortable distance can be tuned further. Various thresholds can be programmed into the lens and the user can select the task appropriate threshold.

Another method is to allow the user to select his/her threshold—the user's preference of when to activate the extra lens power. The lens can use the same system that it uses to measure the user's relative eye position to set the accommodation threshold. There is an overlap where the user's eyes can accommodate unassisted to see adequately and where the user's eyes also can see adequately with the extra power when the lens is active. Providing a means for the user to set this threshold improves the comfort and utility of the lenses. The procedure follows this sequence:
The user prompts the system to start the sequence. Initially the system could prompt the user as a part of the initial calibration and customization;
The lenses are activated. The ability to achieve a comfortable reading position and distance requires the user to actually see the target, thus the lens are in the accommodation state;
The user focuses on a target which is at a representative distance while the system determines the distance based on the angles of the eyes by using the sensor information (accelerometers or magnetometers); after several measurements and noise reduction techniques the system calculates a threshold and indicates that it has finished;
The new threshold has been determined. A slight offset is subtracted to effectively place the threshold a little farther away, thus creating hysteresis. This is necessary to move the threshold slightly longer (angle slightly lower) in order to guarantee when the user is in the same position, the system will accommodate even with small head or body position differences. The value of this hysteresis could be altered by an algorithm that adapts to user habits. Also, the user could manually change the value if the desired by having the system prompt the user to move the focus target to a position that the user does not want the lenses to activate all the while focusing on the target. The system would deactivate the lenses and then determine this distance. The hysteresis value is the difference in the deactivate distance and the activate distance.
Lenses are now on, dependent on the new threshold and hysteresis values.

To have a good user experience, the user needs to have a confirmation that the system has completed any adjustments or customization. In addition, the system needs to determine if the user performed these tasks properly and if not, and then request that the user preforms the procedure again. Such cases may include excessive movement during measurement, head not straight, lens out of tolerance, etc. The interactive experience will result in far less frustrated or unhappy users.

Feedback can be given through various means. Using a phone app provides the most flexibility with the screen, CPU (or other processor), memory, optional internet connection, etc. The methods as discussed for calibration per the embodiments of the present invention can be done in conjunction with the use of the app with use of the communication elements as described in reference to FIG. 1 and with reference to FIG. 3 hereafter.

As a part of continual improvement for the lens, data for the lenses can be collected and sent back to the manufacturer (anonymously) via the app to be used to improve the product. Collected data includes, but not limited to, accommodation cycles, errors, frequency that poor conditions occur, number of hours worn, user set threshold, etc.

Other methods to indicate operation include, but are not limited to, blinking lights, vibrating haptics drivers, and activating the lens. Various patterns of activation of these methods could be interpreted by the user to understand the status of the lens.

Referring now to FIG. 3, shown is another implementation according to an embodiment of the present invention in which sensing and communication may be used to communicate between a pair of contact lenses 305, 307. Pupils 306, 308 are illustrated for viewing objects. The contact lenses 305, 307 include embedded elements 309, 311, such as those shown in FIG. 1. The embedded elements 309, 311 include, for example, 3-axis accelerometers/magnetometers, lens activators, calibration controller, a system controller, memory, power supply, and communication elements as is described in detail subsequently. A communication channel 313 between the two contact lenses 305, 307 allows the embedded elements to conduct calibration between both contact lenses 305, 307. Communication may also take place with an external device, for example, spectacle glasses, a key fob, a dedicated interface device, a smartphone, a tablet, or a computer. Communication between the contact lenses 305, 307 is important to detect proper calibration. Communication between the two contact lenses 305, 307 may take the form of absolute or relative position, or may simply be a calibration signal of one lens to another if there is suspected eye movement. If a given contact lens detects calibration signal different from the other lens, it may activate a change in stage, for example, switching a variable-focus or variable power optic equipped contact lens to the near distance state to support reading. Other information useful for determining the desire to accommodate focus near, for example, lid position and ciliary muscle activity, may also be transmitted over the communication channel 313. It should also be appreciated that communication over the channel 313 could include other signals sensed, detected, or determined by the embedded elements 309, 311 used for a variety of purposes, including vision correction or vision enhancement.

The communications channel 313 may include, but is not limited to, a set of radio transceivers, optical transceivers, or ultrasonic transceivers that provide the exchange of information between both lens and/or between the lenses and the external device used to send and receive information. The types of information include, but are not limited to, current sensor readings showing position, the results of system controller computation, synchronization of threshold and activation. In addition, the external device could upload settings, send sequencing signals for the various calibrations, and receive status and error information from the lenses.

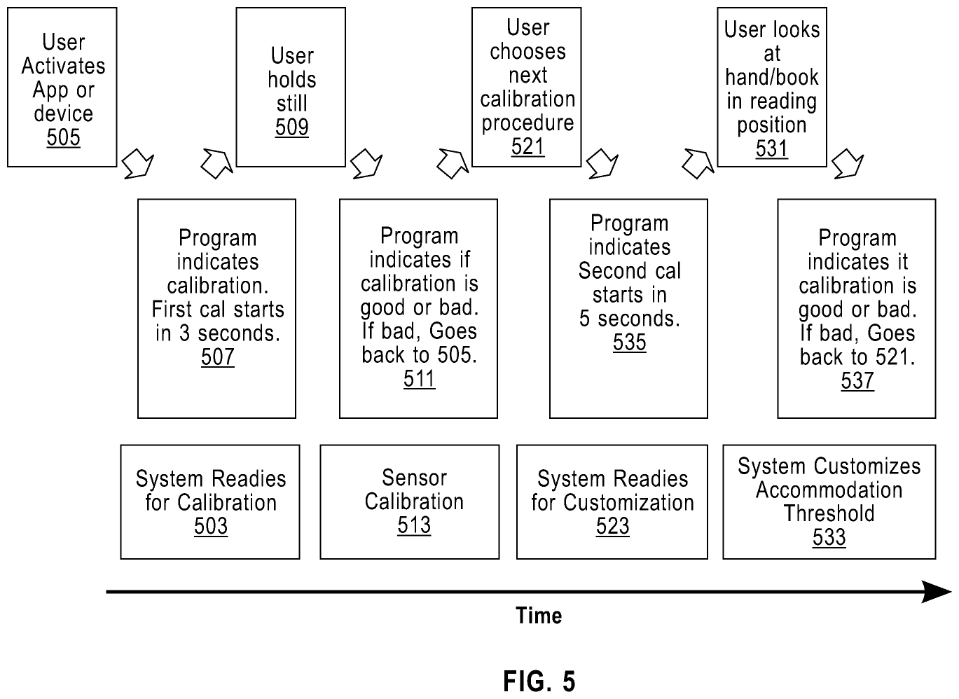

Still referring to FIG. 3, the contact lens 305, 307 in at least one embodiment further communicates with the external device (e.g., a smartphone) 316 or other external communication device. Specifically, an app 318 on the external device 316 communicates to the contact lens 305, 307 via a communication channel 320. The functionally of the app 318 follows the process as outlined with referenced to FIG. 5 (described hereafter) and instructs the user when to perform the required eye movements. In addition, the external device 316 could upload settings, send sequencing signals for the various calibrations, and receive status and error information from the contact lenses 305, 307.

Referring to FIG. 5, another method according to an embodiment of the present invention is depicted. The process starts at an initial time (far left of the figure) and proceeds forward in time. Once the lens (see FIG. 3) is inserted, the system readies for calibration 503. User activates app or device 505. The app program indicates calibration and the first calibration starts in, for example, 3 seconds 507 as part of a first calibration. The user holds still 509 as the system and the sensor calibration 513 starts. The program indicates if calibration is good or bad 511. If calibration is bad the program restarts and goes back (to step 505) 511. After the initial calibration, the system is ready for customization 523. The user chooses the next calibration procedure 521. The program indicates the second calibration will start in, for example, 5 seconds 535 as part the system customization accommodation threshold 533. The user then looks at either his/her hand or a book at reading position 531. The program determines if the second stage of calibration customization is good 537. If the second stage of calibration customization is bad, then the user must restart the calibration customization process 521. Once the program acknowledges that the second stage of calibration customization is good 537, the system has the completed customization accommodation calibration and the lenses are ready for full use by the user.

It is important to note that the above described elements may be realized in hardware, in software implemented on a processor or in a combination of hardware and software. In addition, the communication channel may include various forms of wireless communications. The wireless communication channel may be configured for high-frequency electromagnetic signals, low-frequency electromagnetic signals, visible light signals, infrared light signals, and ultrasonic-modulated signals. The wireless channel may further be used to supply power to the internal embedded power source acting as a primary cell or rechargeable power means.

The present invention may be a system, a method, and/or a computer program product. The computer program product being used by a controller for causing the controller to carry out aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

The corresponding structures, materials, acts, and equivalents of all means plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for calibrating a plurality of multiple wearable ophthalmic lenses each having at least one sensor, a system controller, communication elements, a calibration controller and a power source, the method comprising:
initiating a calibration by the system controller;
causing the at least one sensor to provide control signals to the system controller;
causing the at least one sensor to further provide calibration signals to the calibration controller; and
conducting a calibration sequence by the calibration controller based on the calibration signals from the at least one sensor as a result of user actions which are sensed by the at least one sensor and providing calibration control signals to the system controller.

2. The method according to claim 1, wherein the calibration controller conducting the calibration sequence takes into account user threshold settings.

3. The method according to claim 1, wherein the calibration controller conducting the calibration sequence takes into account customization of thresholds.

4. The method according to claim 1, the method further comprising causing the power source to provide power to the elements in the user-wearable ophthalmic lens.

5. The method according to claim 4, wherein the power source includes a primary cell.

6. The method according to claim 1, the method further comprising communicating by the communication elements with an external user unit.

7. The method according to claim 1, wherein the at least one sensor includes a plurality of sensors providing a plurality of control signals to the system controller.

8. The method according to claim 7, wherein the plurality of sensors further provides a plurality of calibration signals to the calibration controller.

9. The method according to claim 7, wherein the plurality of control signals represents multidimensional control signals.

10. The method according to claim 8, wherein the plurality of calibration signals represents multidimensional calibration signals.

11. A user-wearable ophthalmic lens comprising:
at least one sensor;
a system controller receiving control signals from the at least one sensor;
a calibration controller receiving calibration signals from the at least one sensor; and
the calibration controller being configured to conduct a calibration sequence based on the calibration signals from the at least one sensor as a result of user actions which are sensed by the at least one sensor and providing calibration control signals to the system controller, and
wherein the at least one sensor, the system controller, and the calibration controller are embedded in the user-wearable ophthalmic lens.

12. The user-wearable ophthalmic lens according to claim 11, further comprising a power source for powering the at least one sensor, the system controller, and the calibration controller within the user-wearable ophthalmic lens.

13. The user-wearable ophthalmic lens according to claim 11, further comprising communication elements embedded within the user-wearable ophthalmic lens.

14. The user-wearable ophthalmic lens according to claim 11, wherein the at least one sensor includes a plurality of sensors providing a plurality of control signals to the system controller.

15. The user-wearable ophthalmic lens according to claim 14, wherein the plurality of control signals represents multidimensional control signals.

16. The user-wearable ophthalmic lens according to claim 14, wherein the plurality of sensors are accelerometers.

17. The user-wearable ophthalmic lens according to claim 14, wherein the plurality of sensors are magnetometers.

18. The user-wearable ophthalmic lens according to claim 11, wherein the plurality of sensors provides a plurality of calibration signals to the calibration controller.

19. The user-wearable ophthalmic lens according to claim 18, wherein the plurality of calibration signals represents multidimensional calibration signals.

20. A system comprising:
a user-wearable ophthalmic lens;
at least one sensor;
a system controller receiving control signals from the at least one sensor;
a calibration controller receiving calibration signals from the at least one sensor, the calibration controller being configured to conduct a calibration sequence based on the calibration signals from the at least one sensor as a result of user actions which are sensed by the at least one sensor and providing calibration control signals to the system controller; and
communication elements communicating with the system controller and/or the calibration controller and a smartphone to control the calibration controller, and
wherein the at least one sensor, the system controller, and the calibration controller are embedded in the user wearable ophthalmic lens.
